(19) United States
(12) Patent Application Publication
(10) Pub. No.: US 2012/0227590 A1
(43) Pub. Date: Sep. 13, 2012

(54) COFFEE FILTER WITH COFFEE MEASUREMENT INDICATOR

(76) Inventors: Mark Glotkowski, Washington Township, MI (US); Valentina Glotkowski, Washington Township, MI (US)

(21) Appl. No.: 13/045,602

(22) Filed: Mar. 11, 2011

(51) Int. Cl. A47J 31/06; A47J 31/08

(52) U.S. Cl. 99/279

(57) ABSTRACT

A coffee filter comprising gradations for measuring coffee grounds retained with the coffee filter. Gradations may be embossed into or printed on the filter material, or molded into a frame of a filter basket. The gradations may be labeled with a value defining a volume of coffee grounds retained within the coffee filter.

### TECHNICAL FIELD

Embodiments of the present invention relate generally to coffee filter technology, and more particularly to a coffee filter comprising gradations for measuring coffee grounds.

### BACKGROUND

Brewing coffee typically requires a measuring an amount of coffee grounds to correspond with a particular measurement of water. Depending on the type of coffee, the granularity of the coffee grinds, or the personal preference of the consumer, different ratios of coffee to water may be desired.

Various approaches to measuring coffee have been employed. In one example, a coffee measuring “scoop” is sold together with the coffee. The exterior of the coffee container or packaging may include a measuring table or set of written instructions providing a recommended measure of scoops for varying measures of water. This approach is convenient, but may be problematic in the event the consumer miscounts (or forgets) the number of scoops of coffee added to the filter. Also, the measurement provided on the coffee container may not be appropriate for other coffee grinds or types, such as self-ground coffee.

In another example, a consumer uses traditional measuring devices, e.g. table spoons, measuring cups, etc., to measure an amount of coffee. This approach is common for consumers that grind their own coffee prior to brewing. The disadvantage of this approach is that measuring utensils are often dirtied in the process, requiring washing.

In yet another example, coffee grinds may be packaged in a self-contained permeable filter pouch in various pre-measured amounts. The packaging may include instructions defining the amount of water that is recommended for each pre-measured filter pack. While this approach has the advantage of easy measure and cleanliness, it confines the consumer to a particular brew size corresponding to the amount of grinds in the filter pouch. In addition, this approach is not well-suited for consumers that grind their own coffee prior to brewing.

FIG. 1 is a perspective view of a collection of prior art disposable paper coffee filters 10. Disposable coffee filters are available in a plurality of shapes and configurations. Some filters may have corrugated sides 12, as shown in FIG. 1. Others may not include corrugations, and may fold flat for packaging purposes.

FIG. 2 is a perspective view of a prior art reusable coffee filter 14. Reusable filter 14 is available in a plurality of shapes and configurations. The configuration shown includes screen or mesh filters 16 for retaining the coffee grounds during brewing, and a rigid or semi-rigid frame 18. Reusable filter 14 may also include handle 20.

### SUMMARY

One embodiment of the present invention includes a coffee filter comprising one or more side walls and a bottom surface for retaining coffee grounds. The one or more of the side walls may have one or more gradations for measuring coffee grounds retained with the coffee filter. In an alternative embodiment, the coffee filter comprises one or more side walls joined to define a bottom for retaining coffee grounds.

The side walls and the bottom surface may be continuous surfaces formed of a common material, such as a paper filter. Alternatively, the filter may comprise a basket frame having one or more of the side walls or bottom surface. The side walls or bottom surface may comprise a mesh or screen material for retaining coffee grounds.

Gradations for the coffee filter may be molded into the basket frame, embossed into one or more of the side walls, or printed on one or more of the side walls. The gradations are labeled with a value such as a volume of coffee grounds retained within the coffee filter.

These are non-limiting examples of various embodiments of the present invention. These and other features and embodiments of the present invention are described in greater detail in the Figures and the following written description and claims.

### BRIEF DESCRIPTION OF THE DRAWINGS

FIG. 1 is a perspective view of a collection of prior art disposable paper coffee filters;

FIG. 2 is a perspective view of a prior art reusable coffee filter;

FIG. 3 is a cross-section of a disposable paper coffee filter in accordance with an embodiment of the present invention;

FIG. 4 is a cross-section of a disposable paper coffee filter in accordance with an alternative embodiment of the present invention;

FIG. 5 is a top view of a disposable paper coffee filter in accordance with an embodiment of the present invention; and

FIG. 6 is a cross-section of a reusable coffee filter in accordance with another embodiment of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

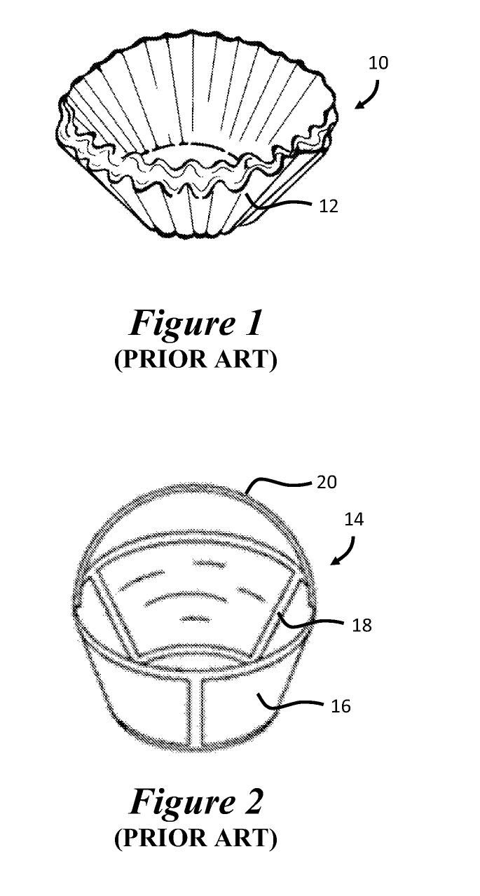

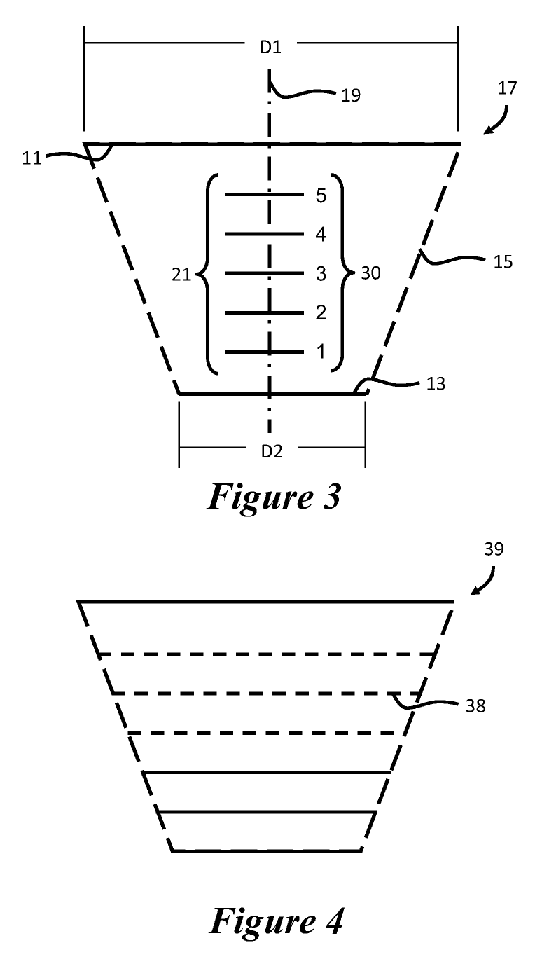

FIG. 3 is a cross-section view of a disposable paper coffee filter 17 in accordance with a preferred embodiment of the present invention. Filter 17 may include a generally circular perimeter top edge 11, a generally circular bottom surface 13 and one or more conical side surfaces 15. While, in this embodiment, filter 17 defines a conical shape about axis 19, the configuration may not be perfectly conical. Other generally conical configurations may be implemented such that diameter or distance D1 is greater than diameter or distance D2. Other geometric filter configurations may be implemented, including cylindrical configurations in which D1 is generally equal to D2, or in which D2 is greater than Dl. In yet another embodiment, two generally-conical side surfaces may be joined along a linear bottom edge 13, as opposed to a circular bottom. Corrugated side surfaces such as shown in FIG. 1, and “perfect” cone configurations having a single conical side surface joining at a bottom cone tip (not shown) may also be implemented.

Coffee filter 17 includes one or more coffee measurement gradations 21 disposed generally vertically between bottom surface 13 and top edge 11. Gradations 21 may be implemented in a variety of different ways. Gradations 21 may be imprinted in the filter paper with non-toxic ink having a visually-observable contrast with respect to the color of the filter paper. Alternatively, the gradations 21 may be embossed into the paper creating a visually-observable coffee measuring mark.

Although not required, gradations 21 may be labeled with suitable measurement values 30. Imprinted measurement values may include numerals (e.g. 1-5 as shown). Alternatively the values may include a variety of volumetric measurements, such as tablespoons, ¼ cup, ½ cup, 1 cup, etc. In some embodiments, the gradations may be labeled with graphical representations of the volumetric measurements (e.g., and without limitation, a graphic of one coffee cup represents one cup, two coffee cups represents two cups, and so forth. Of course, the use of whole numbers is for illustration. Accordingly, fractional amounts may also be represented). The imprinted measurement corresponds to an approximate volume of dry coffee grounds retained by filter 17. The location of the gradations will vary depending on the style and size of coffee filter utilized. Alternatively, gradations 21 may be labeled with values representing a recommended amount of water to be added for the volume of coffee added at gradations 21.

FIG. 4 illustrates a cross-section of an alternative disposable filter configuration 39 in which gradations 38 are continuously disposed about the perimeter or circumference of filter 39. Gradations 38 may be provided in a continuous, dashed or other configuration. Labels (not shown) may also be provided as described above.

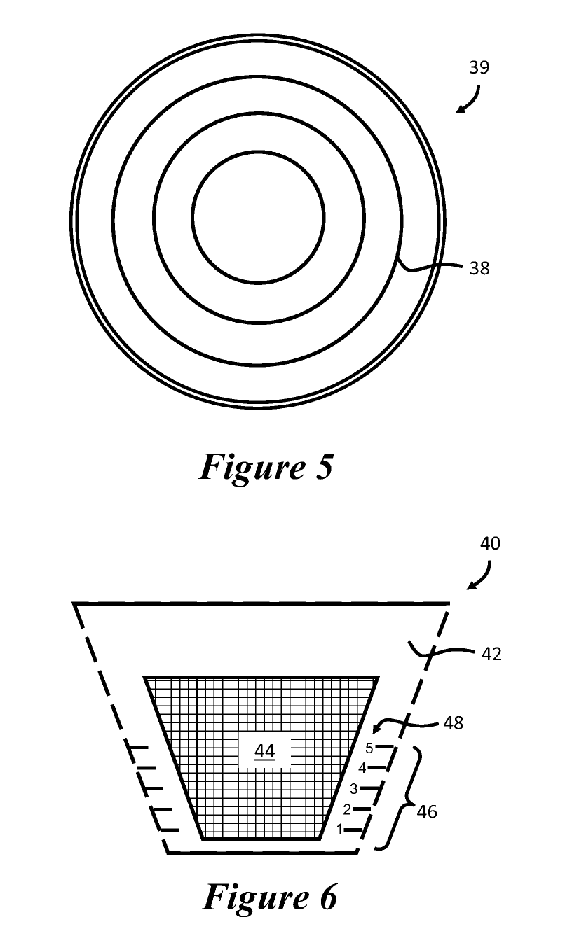

FIG. 5 is a top view of filter 39 showing circumferential gradations 38.

FIG. 6 illustrates a cross-section of a reusable coffee filter 40 constructed of metal, plastic or similar frame material 42. Filter 40 includes one or more screens or mesh regions 44 for retaining coffee grinds within filter 40 during brewing. Screens 44 may be disposed on the sides and/or bottom (not shown) of filter 40. Filter 40 includes one or more coffee measurement gradations 46. Gradations 46 may be printed upon, molded or cast into filter frame 42. Alternatively, gradations 46 may be imprinted or otherwise provided in screen 44. Gradations 46 may be labeled with suitable volumetric measurement values 30 as explained above. Labels 48 may be painted, stamped or cast into filter 40 at frame 42, on the screen 44, or elsewhere.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A coffee filter comprising one or more side walls and a bottom surface for retaining coffee grounds, the one or more of the side walls having one or more gradations for measuring coffee grounds retained with the coffee filter.

2. The coffee filter of claim 1 wherein the side walls and the bottom surface are continuous surfaces formed of a common material.

3. The coffee filter of claim 1 wherein the filter comprises a paper filter.

4. The coffee filter of claim 1 wherein the filter comprises a basket frame and one or more of the side walls or bottom surface comprise a mesh or screen material for retaining coffee grounds.

5. The coffee filter of claim 4 wherein one or more of the gradations are molded into the basket frame.

6. The coffee filter of claim 1 wherein one or more of the gradations are embossed into one or more of the side walls.

7. The coffee filter of claim 1 wherein one or more of the gradations are printed on one or more of the side walls.

8. The coffee filter of claim 1 wherein one or more of the gradations are molded into one or more of the side walls.

9. The coffee filter of claim 1 wherein one or more of the gradations are labeled with a value.

10. The coffee filter of claim 9 wherein the value corresponds to a volume of coffee grounds retained within the coffee filter.

11. A coffee filter comprising one or more side walls joined to define a bottom for retaining coffee grounds, the one or more of the side walls having one or more gradations for measuring coffee grounds retained with the coffee filter.

12. The coffee filter of claim 11 wherein the side walls forming a generally conical shape.

13. The coffee filter of claim 11 wherein the filter comprises a paper filter.

14. The coffee filter of claim 11 wherein the filter comprises a basket frame and one or more of the side walls comprise a mesh or screen material for retaining coffee grounds.

15. The coffee filter of claim 14 wherein one or more of the gradations are molded into the basket frame.

16. The coffee filter of claim 11 wherein one or more of the gradations are embossed into one or more of the side walls.

17. The coffee filter of claim 11 wherein one or more of the gradations are printed on one or more of the side walls.

18. The coffee filter of claim 11 wherein one or more of the gradations are molded into one or more of the side walls.

19. The coffee filter of claim 11 wherein one or more of the gradations are labeled with a value.

20. The coffee filter of claim 19 wherein the value corresponds to a volume of coffee grounds retained within the coffee filter.
